(19) United States
(12) Patent Application Publication
(10) Pub. No.: US 2009/0311528 A1
(43) Pub. Date: Dec. 17, 2009

(54) METHOD FOR PASIVATING NON-RADIATIVE RECOMBINATION CENTRES OF ZnO SPECIMENS AND PASSIVE ZnO SPECIMENS THUS PREPARED

(76) Inventors: Ivan-Christophe Robin, Grenoble (FR); Guy Feuillet, Saint Martin D'Uriage (FR)

Correspondence Address: Commissariat a I'Energie Atomique/BHGL, P.O. Box 10395, Chicago, IL, 60610, US

(21) Appl. No.: 12/480,423

(22) Filed: Jun. 8, 2009

(30) Foreign Application Priority Data
Jun. 12, 2008 (FR) 08 53910

(51) Int. Cl. B05D 5/12; B32B 9/00; B32B 1/08

(52) U.S. Cl. 428/389; 427/126.3; 427/120; 428/697; 428/701; 372/43.01; 257/103

(57) ABSTRACT

Method for passivating non-radiatives recombination centres of a ZnO specimen in which magnesium is deposited on at least one surface of the ZnO specimen, and annealing of the specimen on which magnesium is deposited is performed in an oxidizing atmosphere.

ZnO specimen thus obtained.

### TECHNICAL FIELD

The invention relates to a method for passivating non-radiative recombination centres of ZnO specimens.

More particularly, the invention relates to a method for passivating dislocations, notably in “2D” epitaxial layers or solid ZnO substrates, or surface states or defects, notably in ZnO nanowires.

The invention also relates to passivated ZnO specimens thus prepared,

The technical field of the invention may be defined as that of the preparation of ZnO in whatsoever form, namely substrates, nanowires, thin layers, nanostructures, etc for applications notably in optoelectronics and in any luminous, lighting device based on ZnO such as Light Emitting Diodes (LED), screens, lamps, lasers, polariton lasers etc.

### STATE OF THE PRIOR ART

In order to take full advantage of the force of the exciton in ZnO so as to produce emitters in the UV, notably for LEDs and lasers, etc, a low density of non-radiative recombination centres must be obtained.

These non-radiative recombination centres are notably dislocations and surface states.

Dislocations are non-radiative recombination centres that are very effective in semi-conductors and their density is a limiting factor for radiative yield, in particular in the case of thin ZnO layers.

Surface states, in particular in the case of nanowires, may also act as non-radiative recombination centres.

At the present time, thin layers obtained by growing ZnO on sapphire have a high density of dislocations.

Thus, document [1] describes the growth of ZnO films on sapphire by molecular beam epitaxy with an MgO buffer layer. The mean density of dislocations (“threading dislocations”) in these ZnO films is 4.10⁹/cm².

In the case of solid substrates obtained by hydrothermal growth, the density of dislocations is of the order of 10⁶-10⁷/cm² as mentioned in document [2].

Document [3] demonstrates that Zn₍₁₋ₓ₎MgₓO alloys obtained by molecular beam epitaxy on ZnO substrates have radiative luminescence yields greater than those of ZnO layers, particularly at a high temperature. The width of the emission band as well as the oscillator force of the photoluminescence of these alloys increases appreciably with increasing Magnesium contents x. This is certainly due to fluctuations in the composition of the alloy in magnesium: MgO having a greater forbidden band energy (band gap) than ZnO, excitons are found to be localised in zones where the Mg concentration is lower. This is the same phenomenon as that existing in InGaN alloys, described in document [4], where fluctuations in the composition of the alloy permits localisation of excitons in zones rich in indium, far from defects.

Optical studies carried out in document [3], and which thus concern specimens in which a ZnMgO alloy is directly prepared by growth, demonstrate that at least 15% magnesium should be incorporated in order to increase significantly the radiative luminescence yield, efficiency compared with ZnO. Moreover, growth of the ZnMgO alloy on ZnO is extremely difficult to control.

In view of what has gone before, a need therefore exists for a method enabling non-radiative recombination centres of ZnO to be passivated, such as surface states, dislocations and other non-radiative recombination centres, and consequently the radiative yield, efficiency of any ZnO specimen to be increased, whether this ZnO specimen be in the form of a solid substrate, prepared for example by a hydrothermal method, a “2D” epitaxial layer, or nanowires.

A need also exists for such a method to be simple, reliable and easy to control.

### DESCRIPTION OF THE INVENTION

The goal of the present invention is to provide a method that, among other things, meets these needs.

This goal and yet others are achieved according to the invention, by a method for passivating non-radiative recombination centres of a ZnO specimen (sample), wherein magnesium is deposited on at least one surface of the ZnO specimen, and annealing of the specimen on which magnesium is deposited is performed (carried out) in an oxidizing atmosphere.

The method according to the invention applies to any specimen whatever its form, its size and the method that has enabled it to be obtained.

Thus, the ZnO specimen may be in the form of a solid substrate prepared for example by a hydrothermal method, of at least one nanowire, or of a “2D” layer, for example a “2D” epitaxial layer.

Non-radiative recombination centres may be dislocations and/or surfaces states or defects, or any other crystalline defect.

Generally, when the specimen is in the form of a “2D” layer, the non-radiative recombination centres are dislocations.

Generally, when the specimen is in the form of nanowires, the non-radiative recombination centres are surface states or defects.

Advantageously, annealing is performed in an atmosphere of air, oxygen or air enriched in oxygen.

Air enriched in oxygen is understood to mean that oxygen is present in a concentration greater than its normal concentration in air.

Advantageously, annealing is performed at a temperature of 400 to 1300° C., preferably from 500 to 1300° C., even more preferably from 500 to 1200° C., and better still from 600 to 1200° C., for a period of 5 minutes to 1 day, preferably 30 minutes to 1 day, even more preferably for 30 minutes to 10 hours, and better still for 1 hour to 10 hours.

Advantageously, magnesium is deposited in a quantity expressed as MgO of 0.01 to 20% by weight, preferably 0.04 to 10% by weight, even more preferably 0.5 to 4% by weight, even better 0.5 to 3% by weight, and better still 1 to 3% by weight, for example 10% by weight of the weight of the ZnO specimen.

Advantageously, magnesium is deposited on 2D epitaxial layers or substrates in the form of a thin layer with a thickness of 0.5 nm to 100 μm, preferably 0.5 nm to 10 μm, for example 2 nm, or indeed 2 μm.

The documents of the prior art cited above neither describe nor suggest the use of magnesium to passivate dislocations, surface states or defects and other non-radiative recombination centres of a ZnO specimen.

It may be said that the method according to the invention consists of incorporating magnesium in the form of MgO, generated from a magnesium deposit, in an already prepared ZnO specimen, following the growth or synthesis of ZnO.

Magnesium is provided in a manner totally independent of the preparation of ZnO, and “a posteriori”.

This incorporation is carried out according to the method of the invention by simply depositing magnesium followed by annealing in order to diffuse magnesium to the heart of the dislocations so as to passivate the surface states or defects, notably in the case of ZnO nanowires, and other non-radiative recombination centres.

The method according to the invention is simple, reliable, easy to implement and comprises a limited number of steps, namely: a very simple step of depositing magnesium on a ZnO specimen after the preparation, growth of ZnO and then an annealing step that is equally easy to implement.

The method according to the invention is easy to control in each of its steps but also during the previous step of preparing ZnO. The method according to the invention does not involve processes that are difficult to check or to control, such as the growth of the ZnMgO alloy, or the growth of ZnO on ZnMgO or of ZnMgO on ZnO.

The method according to the invention does not require complex and costly equipment, and in particular it does not make it necessary to use a magnesium cell in a molecular beam epitaxy structure.

The method according to the invention makes it possible to achieve a significant increase in the radiative luminescence yield compared with non-passivated ZnO with magnesium concentrations that are much lower than in the prior art. Thus, according to the invention, magnesium concentrations (expressed as MgO) as low as 0.01% by weight make it possible to increase significantly the luminescence yield, namely by a factor of 20 at ambient temperature, while it is necessary to incorporate at least 15% magnesium in order to increase significantly the radiative luminescence yield compared with ZnO in document [3].

The method according to the invention also makes it possible to obtain an MgO layer on the surface of ZnO nanowires without carrying out lateral growth of MgO.

Magnesium, by a simple method of the evaporation type, is incorporated in non-radiative recombination centres selectively, which is not the case when “alloy fluctuation” is obtained, corresponding to non-homogeneous magnesium compositions, by growth of ZnMgO. In point of fact, zones rich in magnesium are not in the region of non-radiative recombination centres when ZnMgO is prepared directly by growth.

The method according to the invention which passivates, in an effective manner and with a reduced quantity of magnesium, non-radiative recombination centres of ZnO whatever they are, makes it possible to increase the radiative yield of any specimen based on ZnO: this is particularly valuable on account of the fact that ZnO is already a material having exceptional properties for emission in the UV (large gap, high exciton force of 60 meV etc).

It has moreover been found that in the case of nanowires, the method according to the invention may also make it possible to increase considerably carrier mobility on account of the lateral formation of ZnMgO.

The method according to the invention makes it possible to prepare a passivated ZnO, for example in the form of nanowires, never obtained in the prior art, and which intrinsically exhibits as such characteristics and properties that have never been obtained previously, by whatever method.

The invention thus additionally relates to a ZnO specimen in which the non-radiative recombination centres are passivated by ZnMgO or MgO.

“Passivated”, within the meaning of the invention, is understood generally to mean that the non-radiative recombination centres are surrounded by, and in contact with ZnMgO or MgO.

The specimen may be in the form of nanowires with a core of ZnO/shell of ZnMgO or MgO structure.

In particular, as has already been stated, ZnO prepared according to the invention inherently exhibits a radiative yield, efficiency, never hitherto attained. Thus the ZnO specimen passivated according to the invention will be able to have, for a magnesium content expressed as MgO of 0.01 to 20% by weight, preferably 0.04 to 10% by weight, even more preferably 0.5 to 4%, better still 0.5 to 3%, and even better 1 to 3% by weight, a radiative yield (radiative luminescence yield, efficiency) of 10 to 100%, preferably 80 to 100%.

In the case where ZnO is in the form of nanowires, it exhibits, apart from this high, increased, radiative yield, efficiency, an enhanced carrier mobility compared with ZnO in the form of nanowires that has not however been prepared by the method according to the invention.

This enhanced carrier mobility is in addition to an increase in radiative yield, a property that is of value in the preparation of electronic components based on nanowires.

For the magnesium concentration mentioned above, a ZnO specimen prepared by the method according to the invention will generally be able to have a carrier mobility of 1 to 250 cm²/V.s, preferably 150 to 250 cm²/V.s.

The invention finally relates to an opto-electronic device such as a light emitting diode or a laser, including said passivated ZnO specimen.

The invention will be better understood on reading the following detailed description given in an illustrative and non-limiting manner, with reference to the accompanying drawings in which:

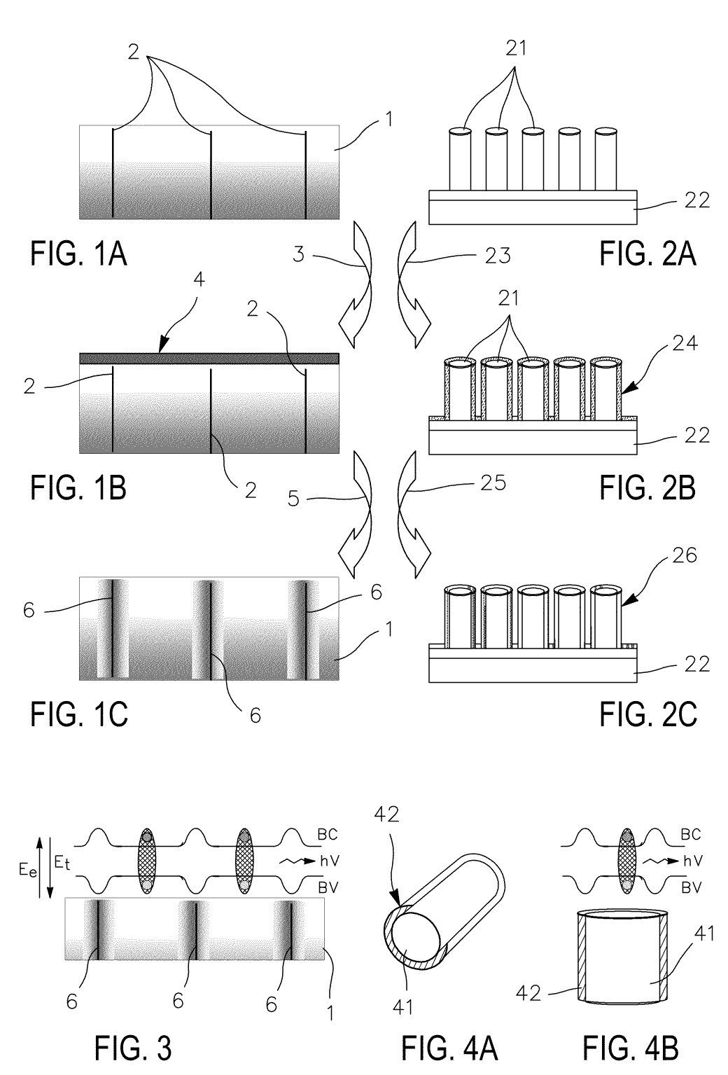

FIGS. 1A, 1B and 1C illustrate the passivation of dislocations of a “2D” layer or of a solid ZnO substrate by the method according to the invention by depositing Mg and then annealing.

FIGS. 2A, 2B and 2C illustrate the passivation of ZnO nanowires by the method according to the invention by depositing Mg and then annealing.

FIG. 3 is a schematic view in vertical section that shows dislocations of a “2D” layer passivated by MgO according to the method of the invention.

FIGS. 4A and 4B show the surface states of nanowires passivated by MgO according to the method of the invention.

The method according to the invention, in the case where passivation of dislocations of a “2D” layer or of a solid substrate is carried out, is illustrated in FIGS. 1A, 1B et 1C.

In FIG. 1A, a ZnO specimen is shown in vertical section (1) that is in the form of a thin “2D” layer with a thickness generally of 2 nm to 1 mm or of a solid substrate, for example, with a thickness of 0.5 mm.

The “2D” layer is generally prepared by an epitaxial growth method on a substrate (not shown) generally made of Al₂O₃ or GaN.

The solid substrate is generally prepared by a hydrothermal growth method.

The substrate or layer has dislocations (2).

The density of these dislocations may be 10³ to 10¹⁰/cm².

In accordance with the method according to the invention, magnesium is deposited (arrow 3) on at least one surface of the ZnO specimen.

The magnesium deposit (4) may take various forms.

This deposit may notably take the form of a magnesium layer (4), preferably deposited on the upper surface of the “2D” layer (1) or of the solid substrate, as shown in FIG. 1B.

Magnesium may be deposited by any suitable technique, for example by cathode sputtering or in an epitaxia structure, frame.

The magnesium deposit may advantageously be prepared at the conclusion of manufacture, growth of ZnO (whatever its form: solid substrate, “2D” layer or indeed nanowires) and immediately thereafter. In other words, it is possible to follow the growth of ZnO by the magnesium deposit advantageously produced by the growth of a magnesium layer.

On account of the fact that magnesium diffuses preferentially along dislocations, a small quantity of magnesium is necessary for passivating the dislocations of a “2D” layer or of a substrate, even with high dislocation densities, for example from 10⁸ to 10¹⁰/cm².

Typically, a thickness of 2 nm of magnesium (expressed as an equivalent quantity of MgO) is generally sufficient to passivate the dislocations of a 500 nm thick “2D” layer as has been demonstrated by experimental results obtained by the inventors.

However, deposition of a larger quantity of magnesium may be desirable, typically an equivalent quantity of MgO of 0.04 to 20%, preferably 1 to 4% of the quantity of ZnO to be treated. Deposition of Mg is a rapid method, much more rapid than the growth of ZnMgO.

The following step of the method according to the invention (arrow 5) is a step of annealing the specimen (1) on at least one surface on which magnesium has been deposited (4).

This annealing step (5) is, in accordance with the invention, performed in an oxidizing atmosphere, namely generally an atmosphere of air, oxygen or air enriched in oxygen.

Annealing (5) is performed at a temperature and for a period sufficient for magnesium to migrate along defects, for example along dislocations, vacancies in the case of a “2D” layer (FIGS. 1A to 1C) and to be oxidized to the MgO form, and so that MgO diffuses around these defects.

On account of the fact that the object of annealing is to oxidize magnesium to the MgO form, annealing under vacuum is not suitable for the annealing step of the method according to the invention, unless magnesium has been previously oxidized to MgO, in particular by air.

Advantageously, annealing, notably in the case of annealing in air, is performed at a temperature of 400 to 1300° C., preferably 500 to 1300° C., even more preferably 500 to 1200° C., and better still 600 to 1200° C., for a sufficient period to cause MgO to diffuse around these defects. This period may be easily determined by a person skilled in the art, and depends notably on the nature and size of the ZnO specimen. It may extend from 5 minutes to 1 day, preferably from 30 minutes to 1 day, even more preferably from 30 minutes to 10 hours, and better still from 1 hour to 10 hours.

At the conclusion of the annealing step of the method according to the invention, a “2D” layer, or a ZnO substrate in which dislocations are passivated, that is to say surrounded by, and in contact with ZnMgO or MgO (6), is obtained as shown in FIG. 1C.

Without wishing to be bound by any particular theory, it has been observed that magnesium easily diffuses in II-VI semiconductors along sites of group II of the lattice (namely Zn in the case of ZnO).

Thus, the dislocations of the “2D” layers or solid substrates may represent preferred paths for the diffusion of magnesium.

This property is very valuable and is profitably used in the method according to the invention since, as has been stated above, dislocations represent very effective non-radiative recombination centres.

If ZnMgO or MgO is formed around dislocations by oxidation of magnesium that has diffused along dislocations as is produced in the method according to the invention at the conclusion of annealing, a potential barrier is obtained around these dislocations on account of the fact that ZnMgO or MgO has a greater forbidden band energy than ZnO.

This potential barrier prevents excitons from non-radiatively recombining on dislocations and a better radiative yield is obtained for the material.

FIG. 3 is a schematic view in vertical section that shows the dislocations of a “2D” layer passivated by MgO or MgZnO (6) according to the method of the invention. In this figure, Eₑ represents the energy of the electrons, Eₜ represents the energy of the holes, and BC and BV represent respectively the valence and conduction bands.

The same principle may be applied for passivating the surface states or defects of nanowires that also act as non-radiative recombination centres.

The method according to the invention in the case where passivation of the states or defects of nanowires is performed, is illustrated in FIGS. 2A, 2B and 2C.

In FIG. 2A, a ZnO specimen has been shown in vertical section that is in the form of nanowires (21) on a substrate (22).

The nanowires (21) are generally in the form of cylinders with a circular or hexagonal generating line with a diameter generally of 5 nm to 20 μm and a length generally of 50 nm to 20 μm. The substrate (22) is generally a substrate made of Al₂O₃ or of GaN or ZnO.

The nanowires (21) are generally prepared by a epitaxial method from organometallics or molecular beam epitaxia on the substrate.

The nanowires have surface defects or states, because of the interface itself or because of the non-homogeneity of the surface, due for example to the topography, the roughness and the composition.

In accordance to the method according to the invention, magnesium is deposited, (arrow 23) on at least one surface of the ZnO specimen.

The magnesium deposit may in the general case take different forms.

In the case of ZnO nanowires (21) this deposit may notably take the form of a layer of magnesium (24), deposited on at least one surface of the nanowires (21) and preferably over all the external surface of the nanowires (21) and of the substrate, as shown in FIG. 2B.

The magnesium deposit (23) may be made by any suitable technique, for example by cathode sputtering or in an epitaxial structure, frame.

The magnesium deposition (23) may advantageously be carried out at the conclusion of the manufacture, growth of ZnO for preparing nanowires and immediately thereafter. In other words, it is possible to follow the growth of ZnO in order to prepare nanowires, by the magnesium deposition.

This magnesium deposit (23) is, in the case of nanowires, advantageously produced by the growth of a magnesium layer (24) preferably of a thin magnesium layer with for example of a thickness of 0.5 to 100 nm.

A small quantity of magnesium is necessary to passivate the surface states or defects of nanowires, even with high surface state or defects densities, for example from 10⁸ to 10¹⁰/cm².

Typically, a thickness of 2 nm of magnesium (expressed as an equivalent quantity of MgO) is generally sufficient to passivate the surface states or defects of nanowires with a size of 2 μm long and 200 nm diameter, which corresponds to approximately 0.5% MgO.

However, deposition of a larger quantity of magnesium may be desirable, typically an equivalent quantity of MgO of 0.1 to 10%, preferably 1 to 2% of the quantity of Zn to be treated.

The following step of the method according to the invention (arrow 25) is a step for annealing the specimen on at least one surface on which magnesium has been deposited.

The annealing conditions are generally the same as those described above for passivating “2D” layers or solid substrates.

Annealing is performed at a temperature and for a sufficient period so that magnesium is oxidized to the MgO form, so that MgO diffuses around the non-radiative recombination centres and so that a shell of MgO or of ZnMgO (26) is obtained on the surface that will act as a potential barrier (FIG. 2C).

At the conclusion of the annealing step of the method according to the invention, ZnO nanowires (41) are obtained in this way as is shown in FIGS. 4A and 4B provided on the surface with an MgO (or MgZnO) shell (42) acting as a potential barrier.

Excitons may then no longer recombine non-radiatively on the surface. This technique is a useful way of producing nanowires with a core/shell structure of ZnO/ZnMgO or ZnO/MgO. The lateral confinement obtained in this way may also make it possible to increase charge mobility in the nanowires.

It should be noted that in the case of ZnO nanowires, magnesium also migrates to the inside of the nanowire after it is deposited while also being present on the surface in order to passivate surface states.

It may thus be said that in the case of nanowires, the non-radiative recombination centres are also surrounded by, and in contact with ZnMgO or with MgO.

The method according to the invention may be used for passivating ZnO employed in all sorts of opto-electronic devices such as light emitting diodes based on ZnO and lasers based on ZnO.

The method according to the invention may notably find an application in light emitting diodes based on ZnO, in which treatment of all the layers containing ZnO may be performed by depositing MgO in order to increase the radiative yield of the diode.

The method according to the invention may also make it possible to avoid the production of ZnMgO/ZnO/ZnMgO quantum wells in the emission zone of a light emitting diode or of a laser.

Confinement is obtained naturally far from defects. Localisation may possibly be as effective as in a quantum well and is obtained by a much simpler method since it is not necessary to control the growth of the ZnMgO alloy, or the growth of ZnO on ZnMgO.

The invention will now be described in relation to the following examples, given in an illustrative and non-limiting manner.

### EXAMPLE 1

Magnesium was deposited by evaporation onto a ZnO substrate or a “2D” layer produced by molecular beam epitaxy on a sapphire substrate and the specimen was annealed for 4 hours in air at 800° C. A passivated “2D” layer was obtained in this way.

### EXAMPLE 2

Magnesium was deposited by evaporation onto a specimen of ZnO nanowires obtained by growth from organometallics (from diethylzinc in the presence of nitrogen protoxide) on a sapphire substrate and the specimen was then annealed for 4 hours in air at 800° C. Passivated nanowires were obtained in this way.

### REFERENCES

[1] B. Pécz, A. El-Shaer, A. Bakin, A. C. Mofor, A. Waag and J. Stoemenos, J. Appl. Phys. 100 103506 (2006).
[2] C. Neumann, Ph.D. Thesis, Physikalisches Institut, Justus-Liebig-Universität, Giefen, Germany, 2006.
[3] H. Shibata, H. Tampo, K. Matsubara, A. Yamada, K. Sakurai, S. Ishizuka, S. Niki and M. Sakai, Appl. Phys. Lett. 90 124104 (2007).
[4] D. Gerthsen, E. Hahn, B. Neubauer, A. Rosenauer, O. Schon, M. Heuken and A. Rizzi, Phys. Status Solidi a 177, 145 (2000).

1. Method for passivating non-radiative recombination centres of a ZnO specimen, wherein magnesium is deposited on at least one surface of the ZnO specimen, and annealing of the specimen on which magnesium is deposited is performed in an oxidizing atmosphere.

2. Method according to claim 1 wherein the ZnO specimen is in the form of a solid substrate, of at least one nanowire, or of a “2D” layer.

3. Method according to any one of the preceding claims, wherein the non-radiative recombination centres are dislocations and/or surface states or defects or any other crystalline defect.

4. Method according to any one of the preceding claims, wherein the specimen is in the form of a “2D” layer, and the non-radiative recombination centres are dislocations.

5. Method according to any one of claims 1 to 3 wherein the specimen is in the form of nanowires and the non-radiative recombination centres are surface states or defects.

6. Method according to any one of the preceding claims wherein annealing is performed in an atmosphere of air, oxygen or air enriched with oxygen.

7. Method according to any one of the preceding claims wherein annealing is performed at a temperature of 400 to 1300° C., preferably 500 to 1300° C., more preferably 500 to 1200° C., better still 600 to 1200° C., for a period of 5 minutes to 1 day, preferably 30 minutes to 1 day, even more preferably 30 minutes to 10 hours, and better still 1 hour to 10 hours.

8. Method according to any one of the preceding claims wherein magnesium is deposited in a quantity expressed as MgO of 0.01 to 20% by weight, preferably 0.04 to 10% by weight, even more preferably 0.5 to 4% by weight, better still 0.5 to 3% by weight, and better still 1 to 3% by weight, of the weight of the ZnO specimen.

9. Method according to any one of the preceding claims wherein magnesium is deposited in the form of a thin layer with a thickness of 0.5 nm to 100 μm, preferably 0.5 nm to 10 μm, for example 2 nm, or indeed 2 μm.

10. ZnO specimen wherein the non-radiative recombination centres are passivated by ZnMgO or MgO.

11. ZnO specimen according to claim 10 wherein the specimen is in the form of nanowires with a core of ZnO/shell of ZnMgO or MgO structure.

12. ZnO specimen according to either of claims 10 or 11 that has a magnesium content expressed as MgO of 0.01 to 20% by weight, preferably 0.04 to 10% by weight, even more preferably 0.5 to 4% by weight, better still 0.5 to 3% by weight, and better still 1 to 3% by weight of ZnO, and a radiative luminescence yield of 10 to 100%, preferably 80 to 100%.

13. Specimen according to claim 12 that is in the form of nanowires and that also has a carrier mobility of 1 to 250 cm²/V.s, preferably 150 to 250 cm²/V.s.

14. Optoelectronic device such as a light emitting diode or a laser including a ZnO specimen according to any one of claims 10 to 13.
